(19) United States
(12) Patent Application Publication
(10) Pub. No.: US 2025/0065782 A1
(43) Pub. Date: Feb. 27, 2025

(54) CAR SEAT DUAL CONNECTION MECHANISM

(71) Applicant: MONAHAN PRODUCTS, LLC, Rockland, MA (US)

(72) Inventors: Manpreet Singh Sokhi, Attleboro, MA (US); Stephen Alan Kender, Hingham, MA (US); Robert Scott Anderson, Narvon, PA (US)

(21) Appl. No.: 18/943,540

(22) Filed: Nov. 11, 2024

Related U.S. Application Data
(63) Continuation-in-part of application No. 18/057,451, filed on Nov. 21, 2022, now Pat. No. 12,139,054.

(51) Int. Cl. B60N 2/26; B62B 9/12

(52) U.S. Cl. CPC B60N 2/274; B62B 9/12

(57) ABSTRACT

According to at least one aspect of the present disclosure a car seat release mechanism is provided. The car seat release mechanism comprises a shell; a first base connection mechanism coupled to the shell and configured to secure the shell to a car seat base, the first base connection mechanism having an open position and a closed position; a first stroller connection mechanism coupled to the shell and configured to secure the shell to a stroller, the first stroller connection mechanism having an open position and a closed position, the first stroller connection mechanism including a hook, a latch configured to receive a hook, a stroller securing portion, and a spring configured to bias the stroller securing portion in the closed position; and a handle coupled to an underside of the shell and configured to operate both the first base connection mechanism and the first stroller connection mechanism.

### CROSS-REFERENCE TO RELATED APPLICATIONS

This application claims priority under 35 U.S.C. § 120 as a continuation-in-part to U.S. application Ser. No. 18/057,451, titled CAR SEAT DUAL CONNECTION MECHANISM, filed on Nov. 21, 2022 and hereby incorporated by reference in its entirety for all purposes.

### BACKGROUND

At least one example in accordance with the present disclosure relates generally to connection mechanisms for car seats. Car seats are seats designed for infants. Car seats typically secure an infant safely in place. Some car seats are designed to attach to a car seat base, the car seat base being directly affixed to part of the car.

### SUMMARY

According to at least one aspect of the present disclosure a car seat release mechanism is provided. The car seat release mechanism comprises a shell; a first base connection mechanism coupled to the shell and configured to secure the shell to a car seat base, the first base connection mechanism having an open position and a closed position; a first stroller connection mechanism coupled to the shell and configured to secure the shell to a stroller, the first stroller connection mechanism having an open position and a closed position, the first stroller connection mechanism including a hook, a latch configured to receive a hook, a stroller securing portion, and a spring configured to bias the stroller securing portion in the closed position; and a handle coupled to an underside of the shell and configured to operate both the first base connection mechanism and the first stroller connection mechanism.

In some examples, the car seat release mechanism further comprises one or more base cables coupled to the handle and coupled to the base connection mechanism, such that when the handle is pulled the base connection mechanism is in the open position; and one or more stroller cables coupled to the handle and to the stroller connection mechanism, such that when the handle is pulled the stroller connection mechanism is in the open position. In various examples, pulling the handle operates both the base and stroller connection mechanisms simultaneously. In many examples, the base connection mechanism comprises a joint; a base securing portion rotationally coupled to the joint, the base securing portion including a travel; and a spring coupled to the base securing portion and configured to bias the base securing portion into the closed position. In some examples, the joint includes a flange configured to secure the base connection mechanism to the shell.

In many examples, the base securing portion is configured to rotate with respect to the travel. In various examples, the car seat release mechanism further comprises a second base connection mechanism, wherein the first base connection mechanism is coupled to a first side of the car seat, and the second base connection mechanism is coupled to a second side of the shell. In some examples, the car seat release mechanism further comprises a first base cable coupled to the first base connection mechanism; and a second base cable coupled to the second base connection mechanism. In various examples, the car seat release mechanism further comprises a hook; a latch configured to receive the hook; a stroller securing portion; and a spring configured to bias the stroller securing portion in the closed position. In many examples, the stroller securing portion includes one or more sides; and the latch includes an aperture configured to receive the hook and one or more beveled edges, wherein the one or more beveled edges are slidably positioned relative to the one or more sides.

In various examples, the latch is configured to slide upwards responsive to the handle being operated, such that the stroller securing portion is shifted to the open position. In some examples, the car seat release mechanism further comprises a second stroller connection mechanism, wherein the first stroller connection mechanism is coupled to a first side of the shell, and the second stroller connection mechanism is coupled to a second side of the shell. In many examples, the car seat release mechanism further comprises a first stroller cable coupled to the first stroller connection mechanism; and a second stroller cable coupled to the second stroller connection mechanism.

According to at least one aspect of the present disclose, a car seat connection mechanism is provided. The car seat connection mechanism comprises a shell; and a connection mechanism having: an open and closed position, a stroller connector configured to connect to a stroller and operable between the open and closed positions, the stroller connector including a hook, a latch configured to receive the hook, a stroller securing portion, and a spring configured to bias the securing portion into the closed position, a base connector configured to connect to a car seat and operable between the open and closed positions, and a handle configured to operate the connection mechanism between the open and closed positions.

In some examples, the connection mechanism further comprises at least one stroller cable coupled to the stroller connector; and at least one base cable coupled to the base connector. In various examples, the connection mechanism further comprises a first stroller connector portion on a first side of the shell; a second stroller connector portion on a second side of the shell; a first stroller cable coupled to the handle and to the first stroller connector portion; and a second stroller cable coupled to the handle to the second stroller connector portion. In many examples, the connection mechanism further comprises a first base connector portion on a first side of the shell; a second base connector portion on a second side of the shell; a first base cable coupled to the handle and to the first base connector portion; and a second base cable coupled to the handle and to the second base connector portion.

In various examples, the base connector has a base open position and a base closed position and the stroller connector has a stroller open position and a stroller closed position. In many examples, the handle is configured to operate the base connector between the base open position and the base closed position and is configured to operate the stroller connector between the stroller open position and the stroller closed position. In some examples, the handle is configured to operate the base connector and the stroller connector simultaneously. In many examples, the car seat connection mechanism further comprises a hook; a latch configured to receive the hook; a securing portion; and a spring configured to bias the securing portion into the closed position.

In some examples, the latch includes an aperture configured to receive the hook and at least one beveled edge; the securing portion includes at least one side slidably positioned with respect to the at least one beveled edge; and the at least one stroller cable is coupled to the hook. In various examples, the car seat connection mechanism further comprises a joint; a securing portion rotationally coupled to the joint; and a spring configured to bias the base securing portion in the closed position. In some examples, the securing portion is coupled to the at least one base cable.

According to at least one aspect of the present disclosure, car seat release mechanism is presented, comprising: a shell; a base connection mechanism coupled to the shell and configured to secure the shell to a car seat base; a stroller connection mechanism coupled to the shell and configured to secure the shell to a stroller, the stroller connection mechanism including a sliding element configured to lock the shell to the stroller in a closed position and to removably connect the shell to the stroller in an open position; and a control mechanism coupled to the base connection mechanism and to the stroller connection mechanism and configured to transition the base connection mechanism and the stroller connection mechanism from a closed position to an open position.

In some examples, the car seat release mechanism further comprises a first plurality of cables coupled to the control mechanism and to the base connection mechanism; and a second plurality of cables coupled to the control mechanism and to the stroller connection mechanism. In some examples, the control mechanism includes a sliding portion coupled to a fixed portion, the fixed portion being coupled to the shell, and the sliding portion being coupled to the first plurality of cables and the second plurality of cables. In some examples, the fixed portion includes one or more channels configured to receive respective protrusions of the sliding portion. In some examples, the car seat release mechanism further comprises a plurality of guide pieces, each respective guide piece coupled to a first cable of the first plurality of cables, and a second cable of the second plurality of cables. In some examples, each cable has a wire element and a sheath element, the sheath element surrounding at least one section of the wire element. In some examples, the stroller connection mechanism includes: a shell portion coupled to the sliding element; a guide element coupled to the shell portion; and a spring coupled between the sliding piece and the guide element. In some examples, the shell portion includes one or more channels configured to receive the sliding element and to allow the sliding element to slide relative to the shell portion. In some examples, the sliding element includes a receptacle configured to receive a portion of at least one cable of the first plurality of cables. In some examples, when the at least one cable is under tension exceeding a biasing force of the spring, the sliding element is pulled away from the shell portion and toward the guide element. In some examples, the base connection mechanism includes: a joint coupled to the shell; and a securing portion rotatably coupled to the joint. In some examples, the securing portion is coupled to at least one cable of the second plurality of cables. In some examples, the securing portion is coupled to a spring configured to bias a securing edge of the securing portion toward a groove of the joint.

According to at least one aspect of the present disclosure, a car seat release mechanism is presented, comprising: a control mechanism; a base connection mechanism including a securing portion rotatably coupled to a joint; a stroller connection mechanism including a sliding element slidably coupled to a shell portion; one or more cables coupled between the control mechanism, the base connection mechanism, and the stroller connection mechanism; and one or more guide pieces coupled to the car seat between the control mechanism, the base connection mechanism, and the stroller connection mechanism, each guide piece of the one or more guide pieces configured to receive a respective first cable of the one or more cables and a respective second cable of the one or more cables, the respective first cable connecting the control mechanism to the base connection mechanism, and the respective second cable connecting the control mechanism to the stroller connection mechanism.

In some examples, the base connection mechanism is biased closed. In some examples, the sliding element is biased into a first position corresponding to the stroller connection mechanism being closed, and configured to transition to a second position corresponding to the stroller connection mechanism being open. In some examples the respective second cable of the one or more cables is coupled to the securing portion, and a second cable of the one or more cables is coupled to the sliding element. In some examples, the control mechanism has a first position and second position, wherein transitioning the control mechanism from the first position to the second position places the base connection mechanism and the stroller connection mechanism in respective open positions, and transitioning the control mechanism from the second position to the first position places the base connection mechanism and the stroller connection mechanism in respective closed positions. In some examples, transitioning the control mechanism from the first position to the second position places the one or more cables under increased tension.

According to at least one aspect of the present disclosure, a car seat release mechanism is presented, comprising: a first connection mechanism configured to couple a car seat to a car seat base; a second connection mechanism configured to couple the car seat to a stroller, the second connection mechanism including a shell portion coupled to the car seat, a guide element coupled to the shell portion, and a sliding element coupled between the shell portion and the guide element and biased into a first position, the first position corresponding to a closed position of the second connection mechanism; a control mechanism configured to simultaneously operate the first connection mechanism and the second connection mechanism; and one or more guide pieces coupled to the car seat, each guide piece configured to receive a respective first cable and a respective second cable, the respective first cable connecting the control mechanism to the first connection mechanism, and the respective second cable connection the control mechanism to the second connection mechanism.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates a schematic diagram of a car seat according to an example;

FIG. 1B illustrates a schematic diagram of a car seat according to an example;

FIG. 2A illustrates a schematic diagram of a connection mechanism for a car seat according to an example;

FIG. 2B illustrates a schematic diagram of the connection mechanism from an angle;

FIG. 3 illustrates a schematic diagram of a handle according to an example;

FIG. 4A illustrates a schematic diagram of a base connection mechanism from a first side according to an example;

FIG. 4B illustrates a schematic diagram of the base connection mechanism from a second side according to an example;

FIG. 5A illustrates a schematic diagram of a stroller connection mechanism from a side view according to an example;

FIG. 5B illustrates a schematic diagram of the stroller connection mechanism from an oblique top-down view according to an example;

FIG. 5C illustrates a schematic diagram of the stroller connection mechanism from a partially exploded view according to an example;

FIG. 6A illustrates a stroller connection mechanism according to an example;

FIG. 6B illustrates a stroller connection mechanism according to an example;

FIG. 7A illustrates a base connection mechanism according to an example;

FIG. 7B illustrates a base connection mechanism according to an example; and

FIG. 8 illustrates a control mechanism according to an example.

### DETAILED DESCRIPTION

Examples of the methods and systems discussed herein are not limited in application to the details of construction and the arrangement of components set forth in the following description or illustrated in the accompanying figures. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Car seats may be designed to connect with car seat bases and with strollers. Strollers and car seat bases often require different connection mechanisms to secure the car seat to the respective stroller or car seat base. Different control mechanisms are used to operate each of the respective connection mechanisms, which is inconvenient. Accordingly, there is a need for a car seat connection mechanism with a single control mechanism that controls both stroller and car seat base connection mechanisms.

Aspects and elements of the present disclosure include a car seat connection mechanism with a single control mechanism that operates both the stroller connection mechanism and the car seat base (“base”) connection mechanism. In some examples, the control mechanism is a handle. In some examples, the control mechanism operates both base and stroller connection mechanisms simultaneously.

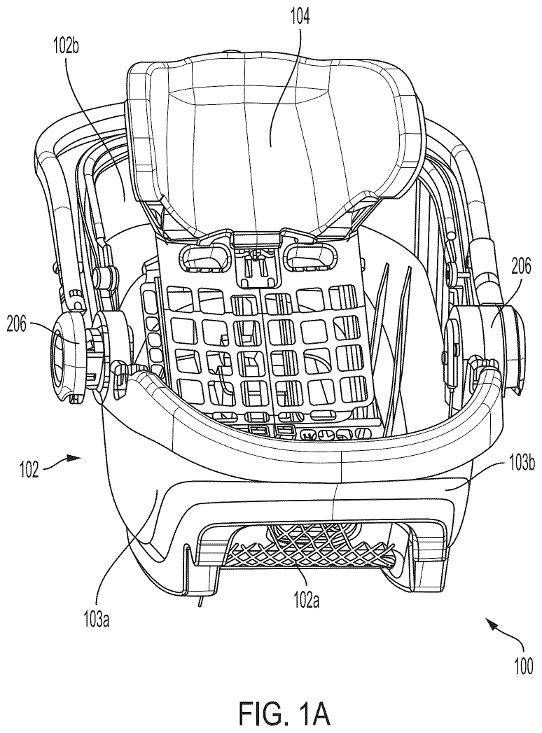

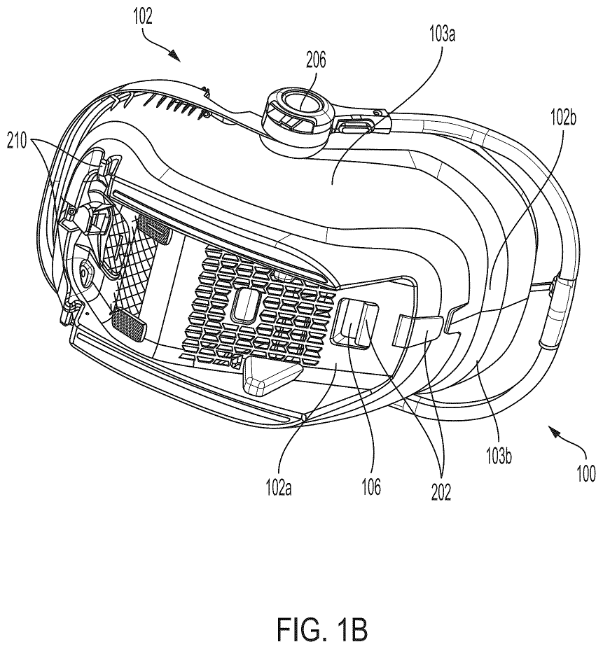

Turning to the figures, FIG. 1A illustrates a schematic diagram of a car seat 100 according to an example.

Car seat 100 includes a shell 102 and a headrest 104. Shell 102 is coupled to a connection mechanism 200 discussed below. Also shown are a stroller connection mechanisms 206 of connection mechanism 200. Shell 102 includes a first half 103a and a second half 103b. Shell 102 also includes an underside 102a and a back 102b.

FIG. 1B illustrates a schematic diagram of car seat 100 according to an example. Car seat 100 includes a handle 202 and base connection mechanisms 210, discussed in greater detail below. Underside 102a of the shell 102 includes an access 106 for handle 202.

With respect to FIGS. 1A and 1B, handle 202, base connection mechanisms 210, and stroller connection mechanism 206 are all coupled to shell 102.

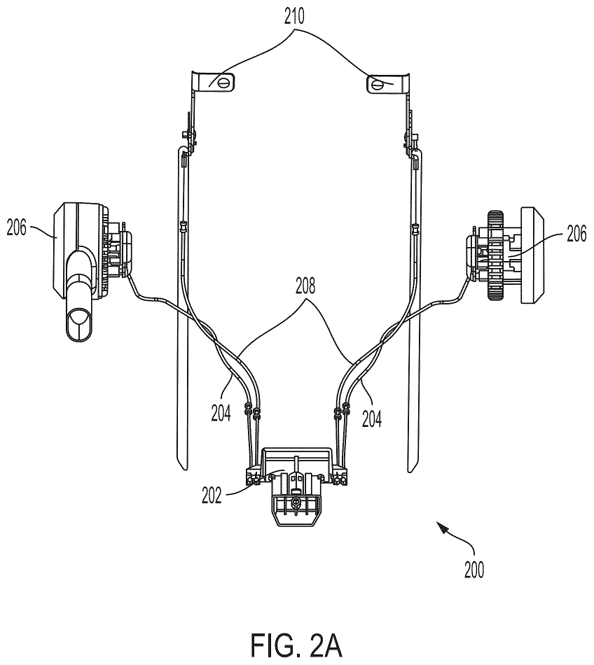

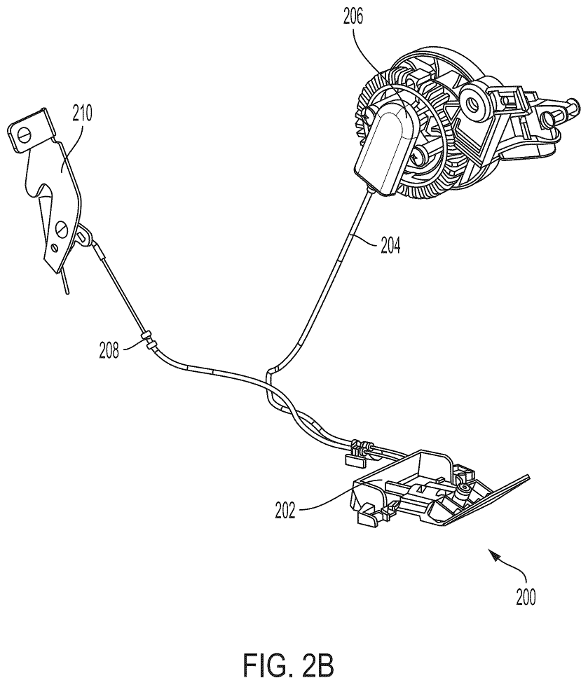

FIGS. 2A and 2B illustrate schematic diagrams of a connection mechanism 200 for a car seat according to an example.

FIG. 2A illustrates a schematic diagram of a connection mechanism 200 according to an example. The connection mechanism 200 includes a control mechanism (“handle”) 202, one or more stroller cables 204, one or more stroller connection mechanisms 206, one or more base cables 208, and one or more base connection mechanisms 210.

Handle 202 is coupled to each stroller cable 204 and base cable 208. Stroller cables 204 are coupled to stroller connection mechanisms 206. Base cables 208 are coupled to base connection mechanism 210.

Stroller connection mechanisms 206 are located on opposite sides of the shell of the car seat, for example opposite sides of the lateral sides of the shell, and are configured to securely connect the car seat to a stroller. Base connection mechanisms 210 are located on opposite sides of the shell, for example, opposite sides of the bottom of the shell, and are configured to securely connect the car seat to a car seat base.

Operating handle 202, for example by pulling the handle, causes cables 204, 208 to pull on the respective connection mechanisms 206, 210 which cause the connection mechanisms to shift from closed positions to open positions. In some examples, operating handle 202 causes connection mechanisms 206, 210 to shift from closed to open positions simultaneously. Handle 202 may operate both connection mechanisms 206, 210 at the same time.

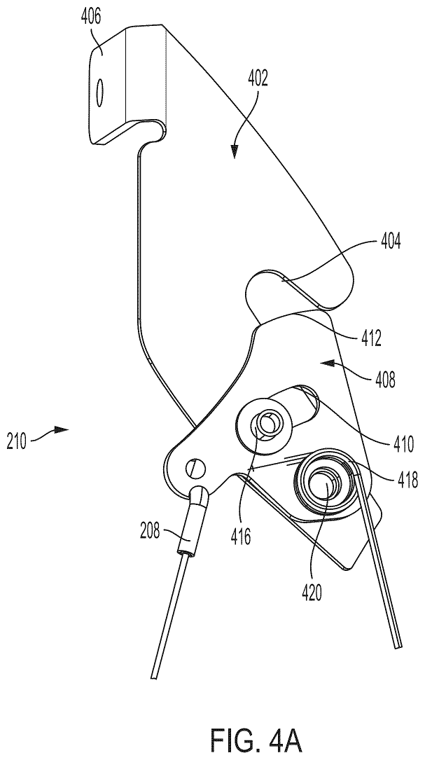

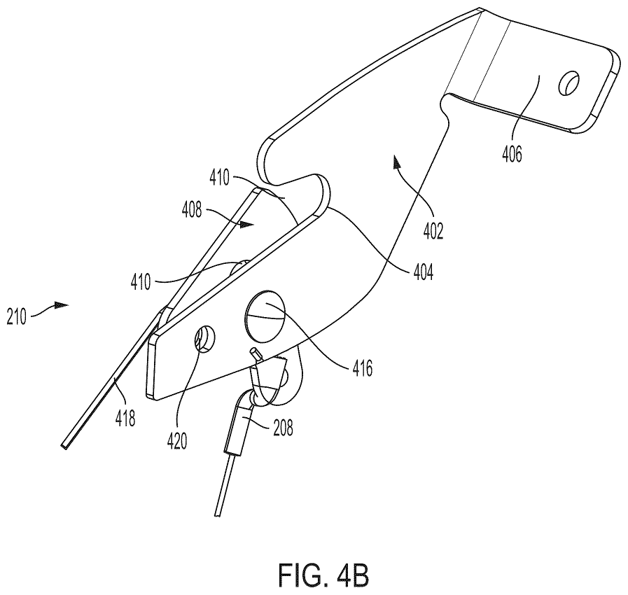

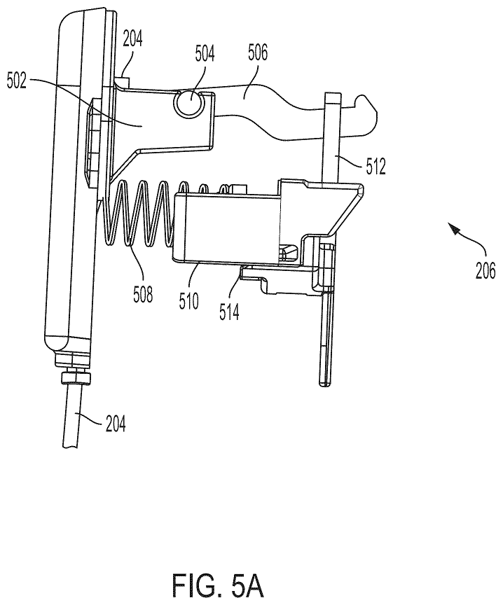

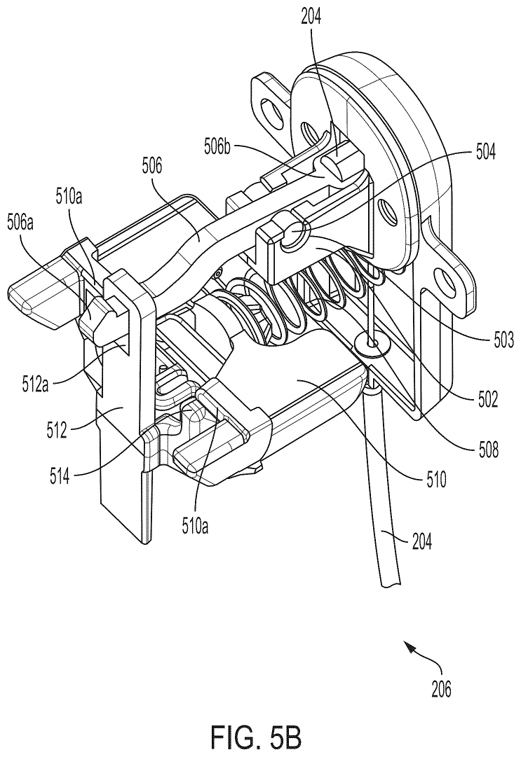

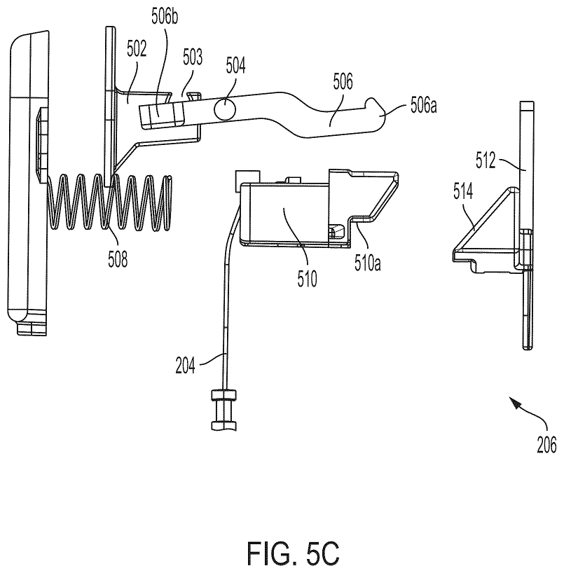

FIG. 2B illustrates a schematic diagram of connection mechanism 200 with one base cable 208, one stroller cable 204, one stroller connection mechanism 206 and one base connection mechanism 210. The base connection mechanism 210 will be discussed in greater detail with respect to FIGS. 4A-4B. The stroller connection mechanism will be discussed in greater detail with respect to FIGS. 5A-5C.

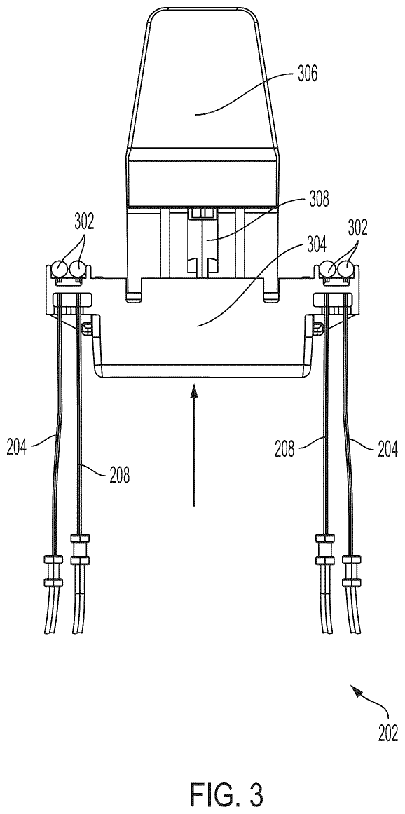

FIG. 3 illustrates a schematic diagram of handle 202 according to an example. Handle 202 includes a sliding portion 304, a channel 308, and a fixed portion 306. Handle 202 further includes fixing elements 302 for coupling the stroller cables 204 and base cables 308 to sliding portion 304.

Sliding portion 304 is slidably coupled to channel 308. Channel 308 is coupled to fixed portion 306. A user may operate handle 202 by, for example, gripping the sliding portion 304 and sliding the sliding portion 304 in the direction of the fixed portion 306. Sliding portion 304 will slide along channel 308 in, for example, various grooves or abutments designed to facilitate the sliding.

When operated, handle 202 exerts force on stroller and base cables 204, 208 pulling the cables away from the respective stroller and base connection mechanisms 206, 210. As tension is thus increased in cables 204, 208 connection mechanisms 206, 210 are operated and put into the open position.

In one example, handle 202 may be operated by a user placing their fingers in the access 106 along underside 102a, and pressing sliding portion 304 which protrudes into access 106 with their fingers. As sliding portion 304 is pressed by the user in the direction of the back 102b (indicated by the arrow in FIG. 3), the cables 204, 208 are tensioned and thus operate the stroller and base connection mechanisms 206, 210 into the open position.

FIGS. 4A-4B illustrate a schematic diagram of base connection mechanism 210 according to an example.

FIG. 4A illustrates base connection mechanism 210 from a first side. Base connection mechanism 210 includes a joint 402, a base securing portion (securing portion) 408, a fixing element 416, and a spring 418. Joint 402 includes a groove 404 and a flange 406. Securing portion 408 includes a travel 410 and a securing edge 412.

Securing portion 408 is rotationally coupled to joint 402 via fixing element 416 which is situated within travel 410 of securing portion 408. Securing portion 408 is coupled to at least one base cable 208. Spring 418 is coupled to the securing portion 408.

Joint 402 includes flange 406 that is configured to couple to the shell of the car seat. For example, joint 402 may be secured to the shell of the car seat via a screw (or other fixing device) placed through the aperture located in the face of flange 406. Flange 406 may project orthogonally, or at an angle, from the remainder of joint 402. Joint 402 also includes a groove 404. Groove 404 is shaped to receive at least a part of the car seat base. For example, the car seat base may have a bar that fits into groove 404. The bar could then be secured in place by securing portion 408, as will be discussed below.

Securing portion 408 includes a travel 410. Travel 410 is a hole in the face of securing portion 408. Travel 410 may be curved and may be of even or approximately even width. Fixing element 416 fits within travel 410 and holds joint 402 and securing portion 408 in proximity to one another. When handle 202 is operated, handle 202 pulls base cable 208. Base cable 208 is coupled to securing portion 408 and pulls securing portion 408 along travel 410. In this manner, securing portion 408 may rotate around a point, for example axis 420, to the extent permitted by travel 410. Securing portion also includes a securing edge 412. Securing edge 412 is slightly wider than groove 404. When a bar or other part of the car seat base is present in groove 404, securing edge 412 holds the bar in place, preventing the bar from exiting groove 404. When the securing edge 412 is positioned to hold the bar in place, base connection mechanism 210 is in the closed position. Spring 418 is configured to bias securing portion 408 into the closed position, such that securing edge 412 is positioned to prevent the bar from exiting groove 404. When handle 202 is pulled, securing portion 408 rotates away from groove 404, and securing edge 412 is displaced such that the bar is no longer held in place. When the bar is no longer held in place within groove 404 by securing edge 408, base connection mechanism 210 is in the open position.

FIG. 4B illustrates the base connection mechanism 210 from a reverse angle compared to FIG. 4A.

FIGS. 5A-5C illustrates schematic diagrams of the stroller connection mechanism 206 according to an example.

FIG. 5A illustrates a schematic diagram of stroller connection mechanism 206 from a side-view. Stroller connection mechanism 206 includes a lodgment 502 for a hook 506, a pivot axis 504, a spring 508, a stroller securing portion (securing portion) 510, a latch 512, and a beveled edge 514 (discussed in greater detail in FIG. 5C).

Lodgment 502 is secured to a portion of car seat 100, and contains a circular aperture 503. Hook 506 includes a circular transverse component called the pivot axis 504 which is fit within circular aperture 503 of lodgment 502. Hook 506 is able to rotate about pivot axis 504. A spring 508 biases securing portion 510 into a closed position. Latch 512 includes an aperture (not shown) which admits the hook 506. Latch 512 further includes a beveled edge 514 slidably contacting a side 510a of securing portion 510. Hook 506 is further coupled to at least one stroller cable 204.

When handle 202 is operated, handle 202 pulls on stroller cable 204. Stroller cable 204 is coupled to hook 506 and pulls one end of hook 506 down. Hook 506 pivots at pivot axis 504 and the opposite end of hook 506 rises. The opposite end of hook 506 is within the aperture of latch 512. Hook 506 thus pulls latch 512 upward. As latch 512 moves upward, beveled edge 514 presses against the side of securing piece 510, forcing securing piece 510 to compress spring 508. When spring 508 is compressed by securing piece 510, stroller securing mechanism 206 is in the open position. When spring 508 is not compressed by securing piece 510 as described above, stroller securing mechanism 206 is in the closed position.

FIG. 5B illustrates a schematic diagram of the stroller connection mechanism 206 from an oblique top-down view.

Hook 506 has a latch-end 506a which is passed through the latch's 512 hole 512a. The latch-end 506a is the end of hook 506 that raises latch 512 upward when handle 202 is operated. Hook 506 also has a receiving end 506b for receiving the stroller cable 204 and securing it to hook 506. Securing portion 510 has a side 510a slidably in contact with beveled edge 514. Side 510a may be perpendicular or at an angle (i.e., complimentarily beveled with respect to beveled edge 514). FIG. 5C illustrates a schematic diagram of the stroller connection mechanism 206 from an exploded view according to an example. The beveled edge 514 may be coupled to the latch 512.

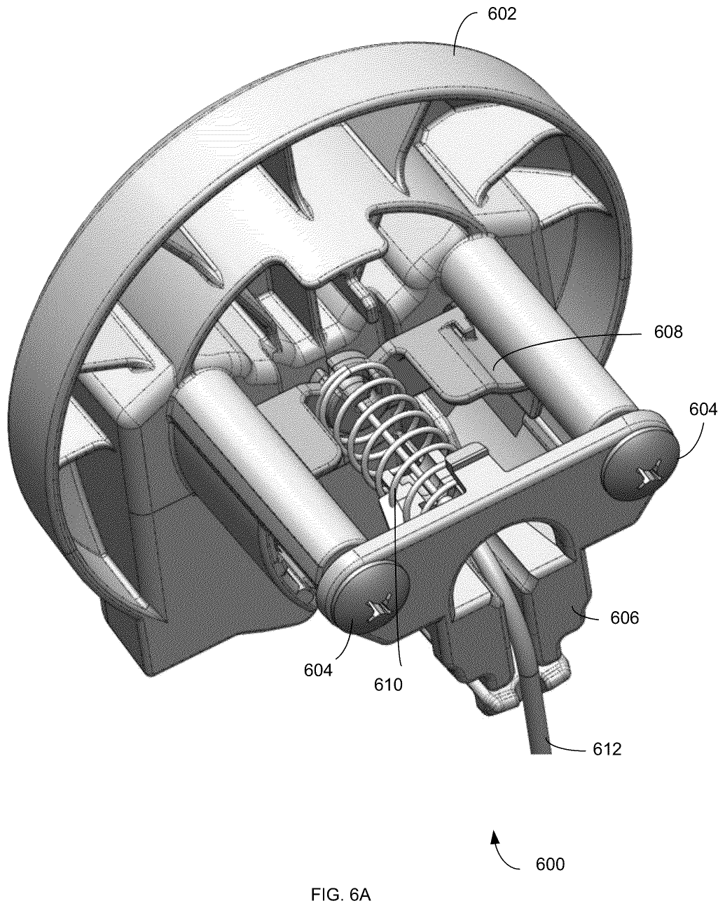

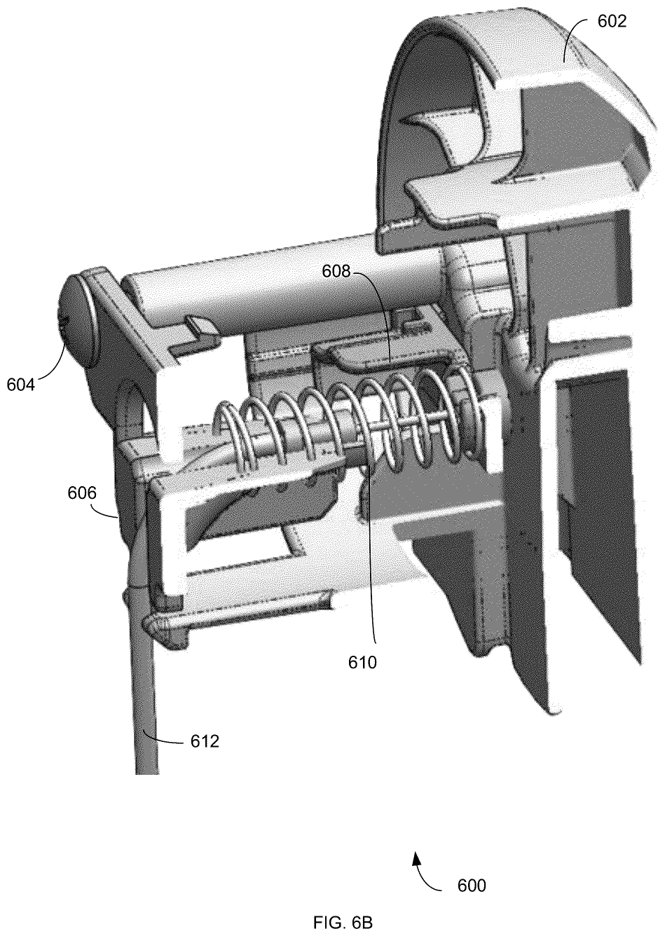

FIG. 6A illustrates a schematic diagram of a stroller connection mechanism 600 according to an example. FIG. 6B illustrates the stroller connection mechanism 600 in a cross-sectioned view according to an example. The stroller connection mechanism 600 serves, in some examples, the same purpose as the stroller connection mechanism 206 of FIGS. 2A and 2B, but differs slightly in various respects. Therefore, in some examples, the stroller connection mechanism 600 may substitute for stroller connection mechanism 206 (e.g., may replace stroller connection mechanism 206).

The stroller connection mechanism 600 includes an outer shell 602, one or more fasteners 604, a guide element 606, a slide element 608 (“slide 608”), a spring 612, and a cable 612. The cable 612 may be one of the stroller cables 204 of FIGS. 2A and 2B.

The outer shell 602 is coupled to the guide element 606. In some examples, the outer shell 602 is coupled to the guide element 606 via the fasteners 604, which may be any type of fastener, for example, screws, nails, bolts, and so forth. The slide 608 is coupled to the outer shell 602. The spring is coupled between the slide 608 and the guide element 606. The cable 612 is coupled to the slide 608 and may be positioned in a channel, canal, or similar depression in the guide element 606. The cable 612 may be coupled to a control mechanism such as the handle 202 of FIGS. 2A and 2B.

The slide 608 is positioned within an abutment of the outer shell 602. The outer shell 602 may include, for example, one or more channels that permit the slide 608 to move in at least two directions along a constant axis (such as the longitudinal axis of the spring 610). The cable 612 may have a first end and a second end, the second end coupled to the control mechanism (e.g., handle 202) and the first end coupled to a ball, disk, or other shape configured to fit within a receptacle of the slide 608. As a result, the cable 612 may be coupled to the slide 608 in such a manner that, when the cable 612 is under tension (e.g., the handle 202 is being operated to pull the cable 612 in a first direction that compresses the spring 610), the slide 608 is pulled toward the guide element 606 and away from the outer shell 602. The spring 610 may be situated between the slide 608 and the guide element 606 such that the spring 610 exerts a biasing force on the slide 608 that biases the slide 608 in the direction of the outer shell 602. Thus, when the cable 612 is not under tension, the slide 608 may be biased by the spring 610 away from the guide element 606 and toward the slide 608.

When the slide 608 is biased against the outer shell 602, the slide 608 may exert pressure on a locking mechanism (such as an interlocking gear or similar mechanism) that locks a stroller seat in place on a stroller, or car seat in place on a car seat receptacle. Thus, when the cable 612 is under tension and the slide 608 is pulled away from the outer shell 602, the car seat or stroller seat may be released from its mounting so that it can be moved, carried, or transferred from one mounting to another. In some examples, rather than exerting pressure on a locking mechanism, the slide 608 may include the locking mechanism, such that pulling the slide 608 away from the outer shell 602 unlocks the seat.

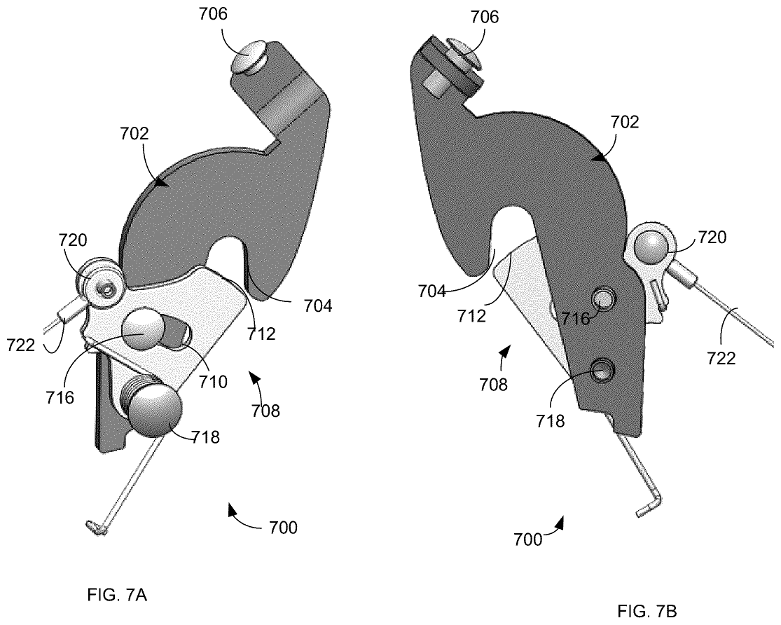

FIG. 7A illustrates a base connection mechanism 700 according to an example. 7B illustrates the base connection mechanism 700 from a reverse view compared to FIG. 7A, according to an example.

The base connection mechanism 700 may replace the base connection mechanism 210 of FIGS. 2A and 2B in some examples. That is, the base connection mechanism 700 is a substitute or may be substituted for the base connection mechanism 210 of FIGS. 2A and 2B.

Base connection mechanism 700 includes a joint 702, a base securing portion (securing portion) 708, a fixing element 716, and a spring 718. Joint 702 includes a groove 704 and a flange 706. Securing portion 708 includes a travel 710 and a securing edge 712.

Securing portion 708 is rotationally coupled to joint 702 via fixing element 716 which is situated within travel 710 of securing portion 708. Securing portion 708 is coupled to at least one base cable 722. Spring 718 is coupled to the securing portion 708.

Joint 702 includes flange 706 that is configured to couple to the shell of the car seat. For example, joint 702 may be secured to the shell of the car seat via a screw (or other fixing device) placed through the aperture located in the face of flange 706. Flange 706 may project orthogonally, or at an angle, from the remainder of joint 702. Joint 702 also includes a groove 704. Groove 704 is shaped to receive at least a part of the car seat base. For example, the car seat base may have a bar that fits into groove 704. The bar could then be secured in place by securing portion 708, as will be discussed below.

Securing portion 708 includes a travel 710. Travel 710 is a hole in the face of securing portion 708. Travel 710 may be curved and may be of even or approximately even width. Fixing element 716 fits within travel 710 and holds joint 702 and securing portion 708 in proximity to one another. When handle 202 is operated, handle 202 pulls base cable 722. Base cable 722 is coupled to securing portion 708 and pulls securing portion 708 along travel 710. In this manner, securing portion 708 may rotate around a point to the extent permitted by travel 710. Securing portion also includes a securing edge 712. Securing edge 712 is slightly wider than groove 704. When a bar or other part of the car seat base is present in groove 704, securing edge 712 holds the bar in place, preventing the bar from exiting groove 704. When the securing edge 712 is positioned to hold the bar in place, base connection mechanism 700 is in the closed position. Spring 718 is configured to bias securing portion 708 into the closed position, such that securing edge 712 is positioned to prevent the bar from exiting groove 704. When handle 202 is pulled, securing portion 708 rotates away from groove 704, and securing edge 712 is displaced such that the bar is no longer held in place. When the bar is no longer held in place within groove 704 by securing edge 708, base connection mechanism 700 is in the open position.

In some examples, securing portion 708 of the base connection mechanism 700 may include a reinforced connection 720 where the base cable 722 is coupled to the securing portion 708.

In some examples, the flange 706 may include one or more fasteners (for example, bolts) for securing the joint 702 to the seat.

In some examples, the base cable 722 may be equivalent to the base cable 208 of FIGS. 2A and 2B.

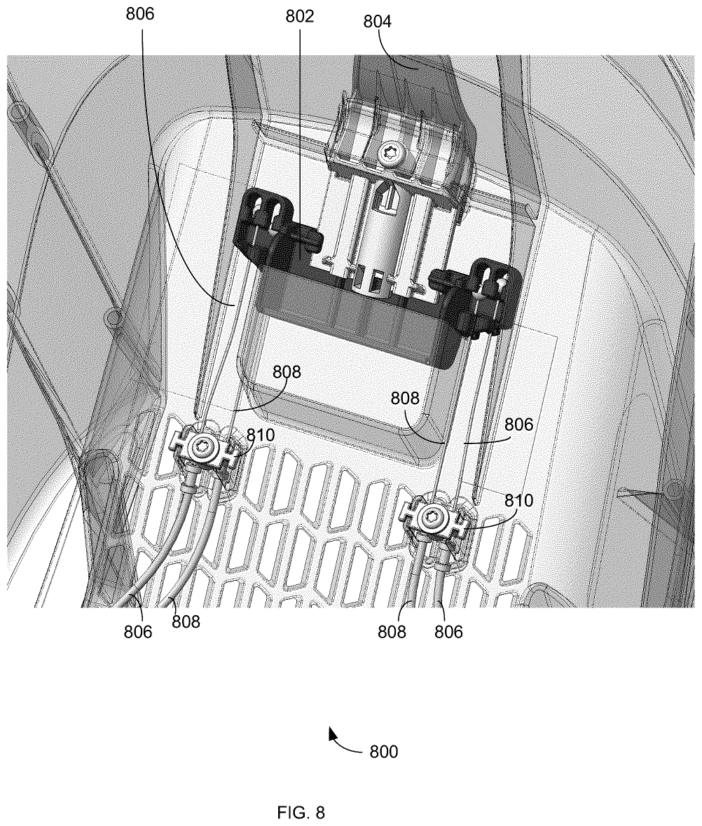

FIG. 8 illustrates a control mechanism 800 (e.g., a handle) according to an example. The control mechanism 800 includes a sliding portion 802, a fixed portion 804, a first plurality of cables 806, a second plurality of cables 808, and a plurality of guide pieces 810.

In some examples, the first plurality of cables 806 may correspond to one of either the base cables (e.g., base cables 208) of FIGS. 2A and 2B or the stroller cables (e.g., stroller cables 204) of FIGS. 2A and 2B. In some examples, the second plurality of cables 808 may correspond to the other of the base cables (e.g., base cables 208) of FIGS. 2A and 2B or the stroller cables (e.g., stroller cables 204) of FIGS. 2A and 2B.

The fixed portion 804 may be coupled to the seat via a fastener, such as a screw, bolt, friction fit, or any other type of fastener. The fixed portion 804 may be coupled to the sliding portion 802. The sliding portion 802 may be coupled to the first and second plurality of cables 806, 808, and the first and second plurality of cables 806, 808 may be coupled to the plurality of guide pieces 810. In at least some examples, each guide piece of the plurality of guide pieces 810 is coupled to a respective cable of the first plurality of cables 806 and a respective cable of the second plurality of cables 808.

In some examples, the cables of the first plurality and second plurality of cables 806, 808 may each constitute two elements, including a wire and a sheath. In some examples, the wire element runs through the sheath element for at least a part of the distance between the control mechanism 800 and the respective stroller connection mechanism 600 or base connection mechanism 700 to which the cable is attached. The sheath element may protect the wire element of the cable from damage. With respect to the control mechanism 800, the sheath may terminate at a guide piece of the plurality of guide pieces 810, and the wire element may continue from a respective guide piece to the sliding portion 802, where the wire element of the cable may be coupled to a receptacle of the sliding portion 802.

The sliding portion 802 is slidably coupled to the fixed portion 804. For example, the fixed portion 804 may contain one or more channels that receive a protrusion of the sliding portion 802. The sliding portion 802 may then slide back and forth along the longitudinal axes of said channels. In some examples, the longitudinal axes of the channels may be parallel to the longitudinal axis of the fixed portion 804.

When the sliding portion 802 is pulled (e.g., slid) toward the fixed portion 804, the pluralities of cables 806, 808 may be placed under tension, thereby unlocking one or both of the stroller connection mechanisms 600 and base connection mechanisms 700. The cables, being under tension, will naturally pull (e.g., slide) the sliding portion 802 away from the fixed portion 804 when force is no longer applied to the sliding portion 802, thus returning the connection mechanisms 600, 700 to the locked portions. That is, the connection mechanisms 600, 700 may be normally locked (e.g., normally closed), and may be biased into the locked position.

The shell may be made from a single piece (for example, a single piece mold) or from multiple pieces joined together. Various locking mechanisms are possible. For example, the base connection mechanism need not retain a single bar for the car seat base, but may also lock into multiple bars or latch to the car seat base in other manners. The base connection mechanism may be located anywhere on the shell, including the sides and back. The stroller connection mechanism need not be located near the middle of the sides of the shell, but could be placed on the front and back of the shell, or biased forward or backward along the sides of the shell. The car seat may have one stroller connection mechanism or multiple. The car seat may have one base connection mechanism or multiple. The biasing mechanisms—the springs—need not be springs, but can be any device capable of generating a biasing force that tends to keep the connection mechanisms in the closed position. The handle may be located anywhere on the shell, and need not be located on the underside of the shell. The handle need not be a sliding mechanism, but can rotate or move in any other manner provided the movement tensions the cables. The cables may be made of any material, for example metals, plastics, synthetics, textiles, and so forth. Likewise, the shell, handle, connection mechanisms, and other parts of the car seat may be made of any suitable material, or any composites of suitable materials, and may be made from different materials than each other, for example metals, plastics, synthetics, textiles, and so forth. In some cases, parts may be fixed together. Such parts may be fixed using bolts, screws, nails, and other fixing elements, welds, or may be cast from the same piece, or otherwise fixed together in an appropriate manner.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A car seat release mechanism comprising:
a shell;
a base connection mechanism coupled to the shell and configured to secure the shell to a car seat base;
a stroller connection mechanism coupled to the shell and configured to secure the shell to a stroller, the stroller connection mechanism including a sliding element configured to lock the shell to the stroller in a closed position and to removably connect the shell to the stroller in an open position; and
a control mechanism coupled to the base connection mechanism and to the stroller connection mechanism and configured to transition the base connection mechanism and the stroller connection mechanism from a closed position to an open position.

2. The car seat release mechanism of claim 1 further comprising:
a first plurality of cables coupled to the control mechanism and to the base connection mechanism; and
a second plurality of cables coupled to the control mechanism and to the stroller connection mechanism.

3. The car seat release mechanism of claim 2 wherein the control mechanism includes a sliding portion coupled to a fixed portion, the fixed portion being coupled to the shell, and the sliding portion being coupled to the first plurality of cables and the second plurality of cables.

4. The car seat release mechanism of claim 3 wherein the fixed portion includes one or more channels configured to receive respective protrusions of the sliding portion.

5. The car seat release mechanism of claim 3 further comprising a plurality of guide pieces, each respective guide piece coupled to a first cable of the first plurality of cables, and a second cable of the second plurality of cables.

6. The car seat release mechanism of claim 2 wherein each cable has a wire element and a sheath element, the sheath element surrounding at least one section of the wire element.

7. The car seat release mechanism of claim 1 wherein the stroller connection mechanism includes:
a shell portion coupled to the sliding element;
a guide element coupled to the shell portion; and
a spring coupled between the sliding piece and the guide element.

8. The car seat release mechanism of claim 7 wherein the shell portion includes one or more channels configured to receive the sliding element and to allow the sliding element to slide relative to the shell portion.

9. The car seat release mechanism of claim 7 wherein the sliding element includes a receptacle configured to receive a portion of at least one cable of the first plurality of cables.

10. The car seat release mechanism of claim 9 wherein when the at least one cable is under tension exceeding a biasing force of the spring, the sliding element is pulled away from the shell portion and toward the guide element.

11. The car seat release mechanism of claim 1 wherein the base connection mechanism includes:
a joint coupled to the shell; and
a securing portion rotatably coupled to the joint.

12. The car seat release mechanism of claim 11 wherein the securing portion is coupled to at least one cable of the second plurality of cables.

13. The car seat release mechanism of claim 12 wherein the securing portion is coupled to a spring configured to bias a securing edge of the securing portion toward a groove of the joint.

14. A car seat release mechanism comprising:
a control mechanism;
a base connection mechanism including a securing portion rotatably coupled to a joint;
a stroller connection mechanism including a sliding element slidably coupled to a shell portion;
one or more cables coupled between the control mechanism, the base connection mechanism, and the stroller connection mechanism; and
one or more guide pieces coupled to the car seat between the control mechanism, the base connection mechanism, and the stroller connection mechanism, each guide piece of the one or more guide pieces configured to receive a respective first cable of the one or more cables and a respective second cable of the one or more cables, the respective first cable connecting the control mechanism to the base connection mechanism, and the respective second cable connecting the control mechanism to the stroller connection mechanism.

15. The car seat release mechanism of claim 14 wherein the base connection mechanism is biased closed.

16. The car seat release mechanism of claim 14 wherein, the sliding element is biased into a first position corresponding to the stroller connection mechanism being closed, and configured to transition to a second position corresponding to the stroller connection mechanism being open.

17. The car seat release mechanism of claim 14 wherein the respective second cable of the one or more cables is coupled to the securing portion, and a second cable of the one or more cables is coupled to the sliding element.

18. The car seat release mechanism of claim 14 wherein the control mechanism has a first position and second position, wherein transitioning the control mechanism from the first position to the second position places the base connection mechanism and the stroller connection mechanism in respective open positions, and transitioning the control mechanism from the second position to the first position places the base connection mechanism and the stroller connection mechanism in respective closed positions.

19. The car seat release mechanism of claim 18 wherein transitioning the control mechanism from the first position to the second position places the one or more cables under increased tension.

20. A car seat release mechanism comprising:
a first connection mechanism configured to couple a car seat to a car seat base;
a second connection mechanism configured to couple the car seat to a stroller, the second connection mechanism including a shell portion coupled to the car seat, a guide element coupled to the shell portion, and a sliding element coupled between the shell portion and the guide element and biased into a first position, the first position corresponding to a closed position of the second connection mechanism;
a control mechanism configured to simultaneously operate the first connection mechanism and the second connection mechanism; and
one or more guide pieces coupled to the car seat, each guide piece configured to receive a respective first cable and a respective second cable, the respective first cable connecting the control mechanism to the first connection mechanism, and the respective second cable connection the control mechanism to the second connection mechanism.
